(19) United States
(12) Patent Application Publication
(10) Pub. No.: US 2008/0224820 A1
(43) Pub. Date: Sep. 18, 2008

(54) LINE DESIGN SYSTEM AND LINE DESIGN METHOD

(76) Inventor: Hiroyuki Tanuma, Tokyo (JP)

Correspondence Address: NEC CORPORATION OF AMERICA, 6535 N. STATE HWY 161, IRVING, TX, 75039, US

(21) Appl. No.: 12/048,030

(22) Filed: Mar. 13, 2008

(30) Foreign Application Priority Data
Mar. 15, 2007 (JP) 2007-067425

(51) Int. Cl. G05B 23/02

(52) U.S. Cl. 340/3.1

(57) ABSTRACT

The present invention provides a line design system which can automatically set a monitoring control channel to a transmission device to which a request for changing a line condition is made when the request for changing a line condition is made. A line design server 20 transmits information on transmission devices 60-1 to 60-n to which the request for changing the line condition is made and information on a monitoring control channel set to the transmission devices 60-1 to 60-n to a network monitoring control device 50 when the request for changing the line condition is made. The network monitoring control device 50 sets a monitoring control channel of the transmission devices 60-1 to 60-n based on the received information on the transmission devices 60-1 to 60-n and the information on the monitoring control channel when receiving the information on the transmission device 60-1 to 60-n and the information on the monitoring control channel.

This application is based upon and claims the benefit of priority from Japanese patent application No. 2007-067425, filed on Mar. 15, 2007, the disclosure of which is incorporated herein in its entirety by reference.

### BACKGROUND OF THE INVENTION

1. Field of the Invention

The present invention relates to a line design system and a line design method, particularly to the line design system and line design method which can automatically change line design.

2. Description of the Related Art

Currently, the line design change is not integrated into product sales of a transmission device used in the line design change, and a considerable time is required to change the line design.

A monitoring control channel is not set in a vender which sells the product of the transmission device, and the monitoring control channel is manually set according to the line design change when an installation trader of the transmission device installs the product of the transmission device.

Thus, the installation of the transmission device necessary for the line design change and the setting of the monitoring control channel to the transmission device are separately performed in the line design change. Therefore, in the case where the transmission device necessary for the line design change is wrongly installed, a considerable time is required to correct the wrong installation.

Therefore, there is a need for development of a system which can automatically change the line design.

There is disclosed a system which reduces a stack load as a technical document applied prior to the present invention (for example, see Japanese Patent Application Laid-Open No. 2001-195530 (patent document 1)).

There is disclosed a system which efficiently designs a network (for example, see Japanese Patent Application Laid-Open No. 2002-215699 (patent document 2)).

There is disclosed a device which can easily and properly select a control target (such as a path) for performing maintenance control in order to improve efficiency and reliability of network management (for example, see Japanese Patent Application Laid-Open No. 2002-374247 (patent document 3)).

There is disclosed a system which can keep SLA while reconstructing the network (for example, see Japanese Patent Application Laid-Open No. 2004-193815 (patent document 4)).

There is a disclosed document about a system which can optimally and dynamically perform communication line setting change according to a requirement, preference, and an environment of an end user (for example, see Japanese Patent Application Laid-Open No. 2005-86628 (patent document 5)).

However, in the patent documents 1 to 5, there is no description, nor suggestion concerning necessity to automatically set the monitoring control channel to the transmission device to which a request for changing a line condition is made in the case where the request for changing the line condition is made.

### SUMMARY OF THE INVENTION

In view of the foregoing, an exemplary object of the present invention is to provide a line design system and a line design method which can automatically set a monitoring control channel to a transmission device to which a request for changing a line condition is made when the request for changing a line condition is made.

### <Line Design System>

A line design system according to the present invention comprises a transmission device which constitutes a network; a line design device which manages a line condition of the transmission device; and a control device which controls a monitoring control channel of the transmission device, wherein the line design device includes a transmission unit which transmits information on a transmission device to which a request for changing a line condition is made and information on a monitoring control channel set to the transmission device to the control device when the change request is made, and the control device includes a control unit which sets a monitoring control channel of the transmission device based on the information on the transmission device and the information on the monitoring control channel when receiving the information on the transmission device and the information on the monitoring control channel.

### <Line Design Method>

A line design method according to the present invention includes a transmission device which comprises a network; a line design device which manages a line condition of the transmission device; and a control device which controls a monitoring control channel of the transmission device, wherein the line design device performs a transmission step of transmitting information on a transmission device to which a request for changing a line condition is made and information on a monitoring control channel set to the transmission device to the control device when the change request is made; and the control device performs a control step of setting a monitoring control channel of the transmission device based on the information on the transmission device and the information on the monitoring control channel when the information on the transmission device and the information on the monitoring control channel are received.

### BRIEF DESCRIPTION OF THE DRAWINGS

FIG. 1 shows an example of a configuration of a line design system of the exemplary embodiment of the present invention;

FIG. 2 is a first sequence chart showing an example of a series of control operations in the line design system of the exemplary embodiment of the present invention; and

FIG. 3 is a second sequence chart showing an example of the series of control operations in the line design system of the exemplary embodiment of the present invention.

### DESCRIPTION OF THE EXEMPLARY EMBODIMENTS

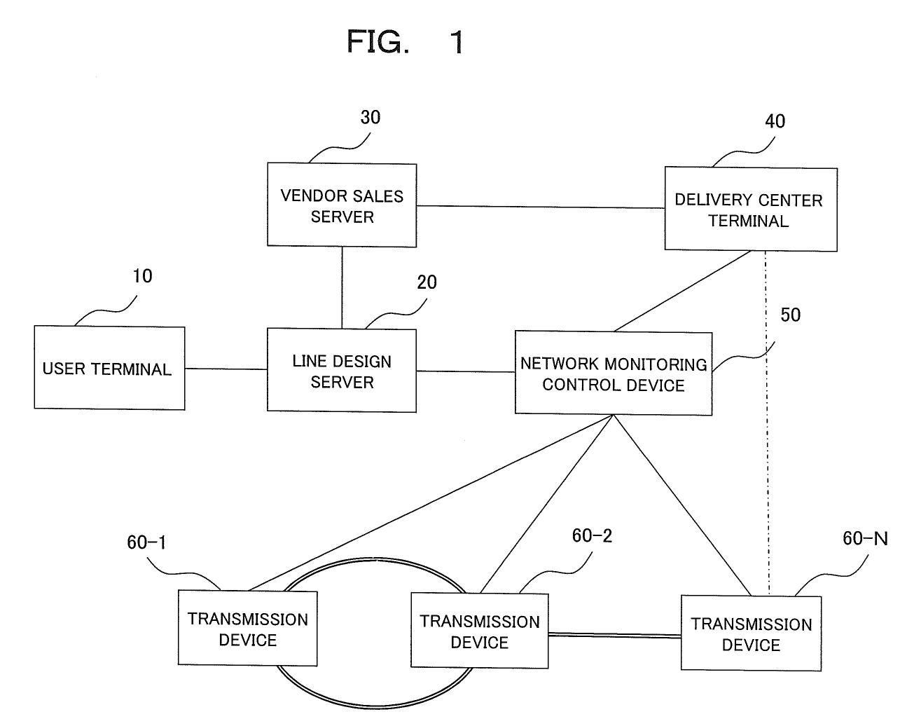

An outline of a line design system according to the exemplary embodiment will be described below with reference to FIG. 1.

The line design system of the exemplary embodiment includes transmission devices 60-1 to 60-n (n is an arbitrary integer) comprising a network, a line design device (corresponding to line design server 20) managing line conditions of the transmission devices 60-1 to 60-n, and a control device (corresponding to network monitoring control device 50) controlling monitoring control channels of the transmission devices 60-1 to 60-n.

When a request is made to change the line condition, the line design device 20 transmits information on the transmission devices 60-1 to 60-n to which the change request is made and information on the monitoring control channels set to the transmission devices 60-1 to 60-n to the control device 50.

When receiving the information on the transmission devices 60-1 to 60-n and the information on the monitoring control channels, the control device 50 sets the monitoring control channels of the transmission devices 60-1 to 60-n based on the received information on the transmission devices 60-1 to 60-n and the received information on the monitoring control channels.

The line design system of the exemplary embodiment includes the transmission devices 60-1 to 60-n (n is an arbitrary integer) comprising the network, the line design device (corresponding to line design server 20) managing the line conditions of the transmission devices 60-1 to 60-n, management devices (corresponding to vendor sales server 30 and delivery center terminal 40) managing installation states of the transmission devices 60-1 to 60-n, and the control device (corresponding to network monitoring control device 50) controlling the monitoring control channels of the transmission devices 60-1 to 60-n.

When the request is made to change the line condition, the line design device 20 transmits the information on the transmission devices 60-1 to 60-n to which the change request is made and the information on the monitoring control channels set to the transmission devices 60-1 to 60-n to the management devices 30 and 40.

When receiving the information on the transmission devices 60-1 to 60-n and the information on the monitoring control channels, the management devices 30 and 40 specify the transmission devices 60-1 to 60-n to which the change request is made based on the information of the transmission devices 60-1 to 60-n, and the management devices 30 and 40 manage the installation states of the transmission devices 60-1 to 60-n. The management devices 30 and 40 transmit the information on the transmission devices 60-1 to 60-n and the information on the monitoring control channels to the control device 50.

When receiving the information on the transmission devices 60-1 to 60-n and the information on the monitoring control channels, the control device 50 sets the monitoring control channels of the transmission devices 60-1 to 60-n based on the received information on the transmission devices 60-1 to 60-n and the received information on the monitoring control channels.

Therefore, when the request is made to change the line condition, the monitoring control channels can automatically be set to the transmission devices 60-1 to 60-n to which the change request is made. Then, the line design system of the exemplary embodiment will be described in detail with reference to the drawings.

### <Configuration of Line Design System>

A configuration of the line design system of the exemplary embodiment will be described in detail with reference to FIG. 1.

The line design system includes a user terminal 10, a line design server 20, a vendor sales server 30, a delivery center terminal 40, a network monitoring control device 50, and transmission devices 60-1 to 60-n (n is an arbitrary integer).

A connection state among the user terminal 10, the line design server 20, the vendor sales server 30, the delivery center terminal 40, the network monitoring control device 50, and the transmission devices 60-1 to 60-n comprising the line design system of the exemplary embodiment is not particularly limited, but any connection state can be applied irrespective of wired or wireless communication as long as information communication can be conducted. For example, the connection can be performed by a communication line such as an IP network.

### <User Terminal 10>

The user terminal 10 is an information processing device such as a personal computer. The user terminal 10 accesses a line design function of the line design server 20 to display design information managed by the line design server 20 on a display unit of the user terminal 10.

Examples of the design information include model names of the transmission devices 60-1 to 60-n, an interface board name, information on connection among the transmission devices 60-1 to 60-n, and the monitoring control channel or the like.

When a change manipulation such as addition and deletion of the transmission devices 60-1 to 60-n is performed by a user's operation, the user terminal 10 transmits the change manipulation information to the line design server 20, the user terminal 10 obtains contents of the line design change according to the change manipulation information from the line design server 20, and the user terminal 10 displays the obtained contents of the line design change on the display unit thereof.

The user terminal 10 also includes a function of providing an instruction to the line design server 20 to reflect the contents of the line design change on the transmission devices 60-1 to 60-n.

### <Line Design Server 20>

The line design server 20 is an information processing device such as a workstation server installed in a line design department of a user. When receiving the change manipulation information from the user terminal 10, the line design server 20 has a line design function of performing the line design change of the line condition based on the received change manipulation information to transmit the contents of the line design change to the user terminal 10.

Examples of the change contents include the model names of the transmission devices 60-1 to 60-n to which the line design change is performed, the interface board name, the information on the connection among the transmission devices 60-1 to 60-n, and the monitoring control channel or the like.

When an instruction for reflecting the change contents of the line design change on the transmission devices 60-1 to 60-n is provided through the user terminal 10, the line design server 20 makes a request to the vendor sales server 30 for line design change information necessary by the contents of the line design change.

Examples of the line design change information include positional information on the transmission devices 60-1 to 60-n to which the line design change is performed, the design change information (addition/deletion) on the transmission devices 60-1 to 60-n, path design change information (information for changing design of a start point and an end point of a path), monitoring control channel design change information (information for changing design of the monitoring control channel), information on a shelf position, information on a package name, and information on a slot position or the like.

### <Vendor Sales Server 30>

The vendor sales server 30 is an information processing device such as workstation server installed in a sales department of a vendor. When receiving the line design change information from the line design server 20, the vendor sales server 30 gives an instruction to the delivery center terminal 40 for product delivery information on the transmission devices 60-1 to 60-n necessary by the line design change and design change information on the transmission devices 60-1 to 60-n based on the received line design change information. When receiving a line design change completion notification from the delivery center terminal 40, the vendor sales server 30 performs billing processing to transmit billing information and the line design change completion notification to the line design server 20.

Examples of the delivery information include the positional information on the transmission devices 60-1 to 60-n to which the line design change is performed, the information on the shelf position, the information on the package name, and the information on the slot position or the like.

Examples of the design change information include the design change information (addition/deletion) on the transmission devices 60-1 to 60-n, the path design change information (information for changing the design of the start point and the end point of the path), and the monitoring control channel design change information (information for changing the design of the monitoring control channel) or the like.

### <Delivery Center Terminal 40>

The delivery center terminal 40 is an information processing device such as a workstation server installed in a product sales department. When receiving the delivery information and the design change information from the vendor sales server 30, the delivery center terminal 40 specifies products of the transmission devices 60-1 to 60-n necessary by the line design change from a stock based on the received delivery information, and the delivery center terminal 40 delivers the products of the specified transmission devices 60-1 to 60-n to a customer in which the transmission devices 60-1 to 60-n to which the line design change is required are installed. When the installation of the transmission devices 60-1 to 60-n to which the line design change is required is completed, the delivery center terminal 40 transmits the design change information received from the vendor sales server 30 to the network monitoring control device 50, and the delivery center terminal 40 provides an instruction for the line design change to the network monitoring control device 50. When receiving the notification that the line design change is completed, the delivery center terminal 40 notifies the vendor sales server 30 of the line design change completion.

### <Network Monitoring Control Device 50>

The network monitoring control device 50 is an information processing device such as a workstation server installed in a line design department of a user. When receiving the design change information from the delivery center terminal 40, the network monitoring control device 50 performs the line design change of the transmission devices 60-1 to 60-n based on the received design change information.

Examples of the line design change include the design change (addition/deletion) of the transmission devices 60-1 to 60-n, the path design change (information for changing the design of the start point and the end point of the path), and the design change of the monitoring control channel or the like.

<Transmission Device 60-1 to 60-n>

The transmission devices 60-1 to 60-n are a transmission device such as TDM and DWDM which is installed in facilities of the user. In the transmission devices 60-1 to 60-n, the design change of the transmission devices 60-1 to 60-n, the path design change, the design change of the monitoring control channel are performed by the line design change of the network monitoring control device 50.

### <Control Operation of Line Design System>

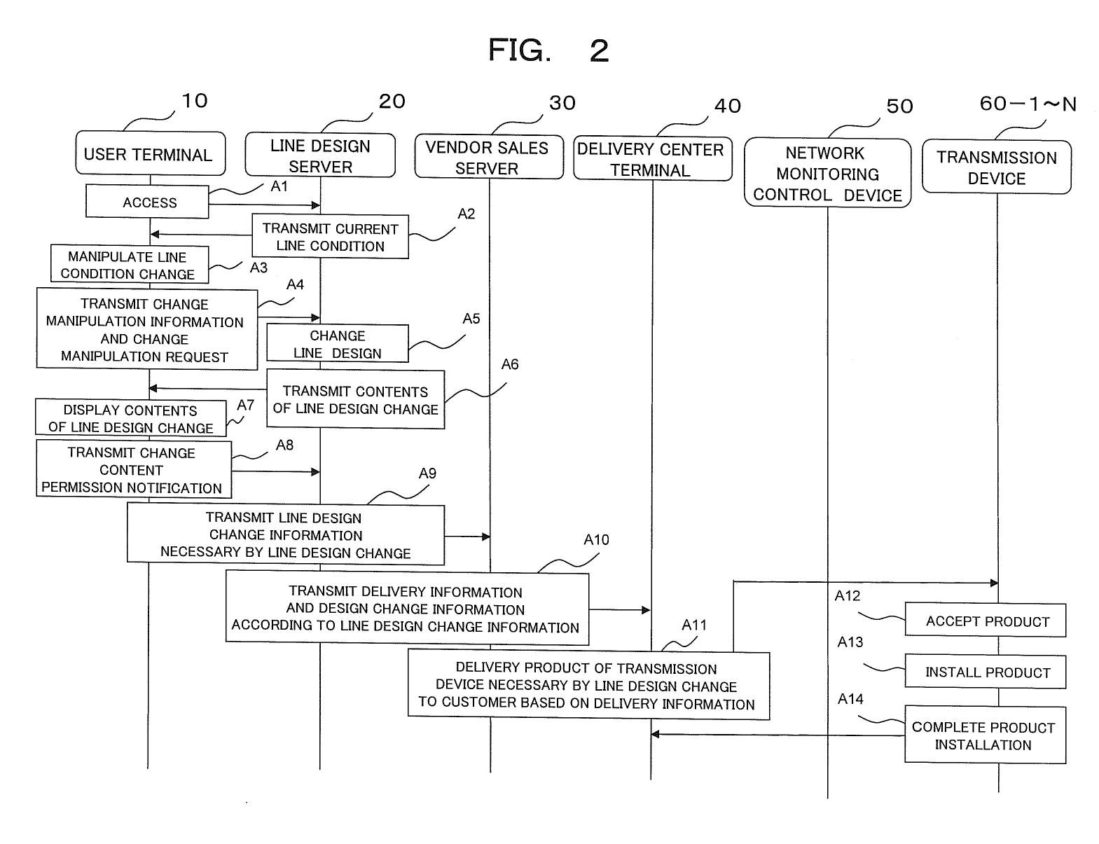

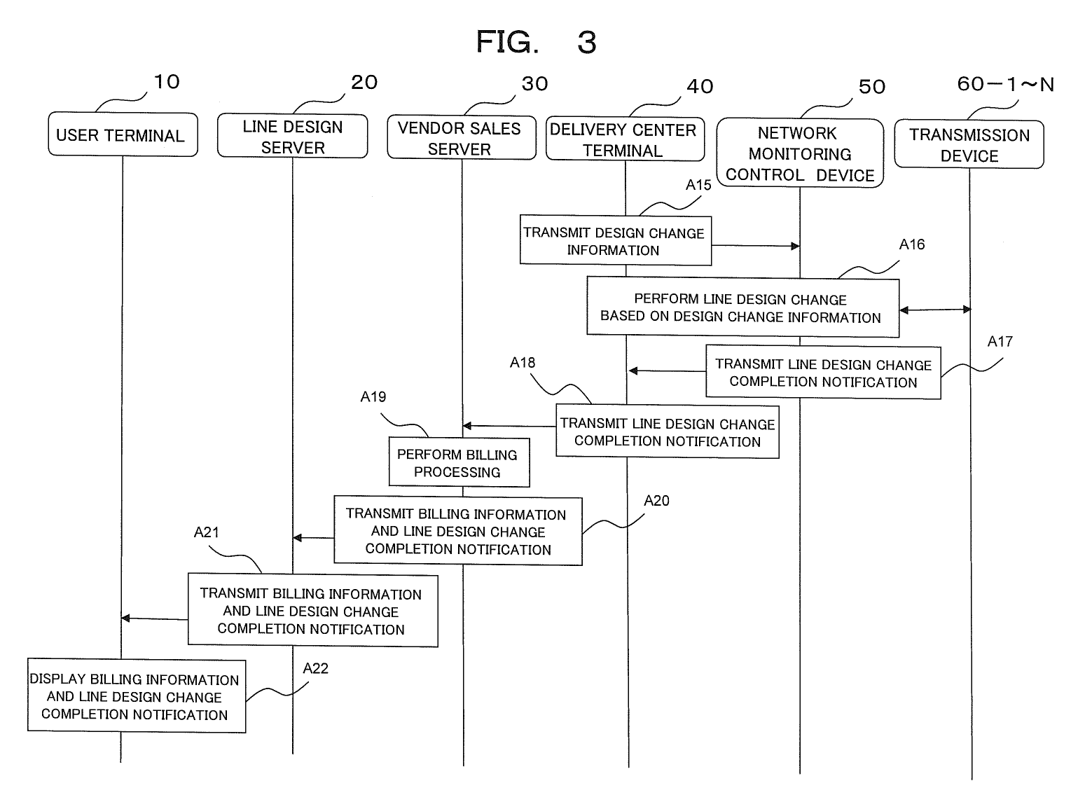

A series of control operations in the line design system of the exemplary embodiment will be described below with reference to FIGS. 1 to 3. FIGS. 2 and 3 show a series of control operations in the line design system.

The user manipulates the user terminal 10 to access the line design server 20 (Step A1).

In response to the access from the user terminal 10, the line design server 20 transmits current design information managed by the line design server 20 to the user terminal 10.

Examples of the design information include the model names of the transmission devices 60-1 to 60-n, the interface board name, the information on the connection among the transmission devices 60-1 to 60-n, and the monitoring control channel or the like.

Therefore, the line design server 20 transmits the current line conditions of the transmission devices 60-1 to 60-n managed by the line design server 20 to the user terminal 10 (Step A2).

The user terminal 10 displays the current line conditions of the transmission devices 60-1 to 60-n received from the line design server 20 on the display unit of the user terminal 10.

On the basis of the current line conditions of the transmission devices 60-1 to 60-n displayed on the display unit of the user terminal 10, the user performs line change manipulation such as addition and deletion of the transmission devices 60-1 to 60-n using the user terminal 10, and the user performs the change manipulation of the current line condition (Step A3).

When the change manipulation of the line condition is completed, the user makes a request for performing the change manipulation of the line condition to the user terminal 10.

When the request for performing the change manipulation of the line condition is made, the user terminal 10 transmits the change manipulation information in performing the change manipulation of the current line condition by the manual operation and the request for performing the change manipulation of the line condition to the line design server 20 (Step A4).

When receiving the change manipulation information and the change manipulation request from the user terminal 10, the line design server 20 performs the line design change of the current line conditions of the transmission devices 60-1 to 60-n (Step A5) base on the received change manipulation information.

Examples of the contents of the line design change includes the change in connection condition among the transmission devices 60-1 to 60-n such as the addition and deletion of the transmission devices 60-1 to 60-n and the change in monitoring control channel or the like.

The line design server 20 transmits the contents of the line design change performed in Step A5 to the user terminal 10 (Step A6).

The user terminal 10 displays the contents of the line design change received from the line design server 20 on the display unit of the user terminal 10 (Step A7).

When the user permits the contents of the line design change displayed on the display unit of the user terminal 10, the user manipulates the user terminal 10 to transmit a change content permission notification to the line design server 20 (Step A8).

When receiving the change content permission notification from the user terminal 10, the line design server 20 transmits the line design change information necessary by the line design change to the vendor sales server 30 based on the contents of the line design change performed in Step A5 (Step A9).

Examples of the line design change information include the positional information on the transmission devices 60-1 to 60-n to which the line design change is performed, the design change information (addition/deletion) on the transmission devices 60-1 to 60-n, the path design change information (information for changing the design of the start point and the end point of the path), the monitoring control channel design change information (information for changing the design of the monitoring control channel), the information on the shelf position, the information on the package name, and the information on the slot position or the like.

When receiving the line design change information from the line design server 20, the vendor sales server 30 transmits the product delivery information on the transmission devices 60-1 to 60-n necessary by the line design change and the design change information on the transmission devices 60-1 to 60-n to the delivery center terminal 40 based on the line design change information (Step A10).

Examples of the delivery information include the positional information on the transmission devices 60-1 to 60-n to which the line design change is performed, the information on the shelf position, the information on the package name, and the information on the slot position or the like.

Examples of the design change information include the design change information (addition/deletion) on the transmission devices 60-1 to 60-n, the path design change information (information for changing the design of the start point and the end point of the path), and the monitoring control channel design change information (information for changing the design of the monitoring control channel) or the like.

When receiving the delivery information and the design change information from the vendor sales server 30, the delivery center terminal 40 specifies the products of the transmission devices 60-1 to 60-n necessary by the line design change from the stock based on the delivery information received from the vendor sales server 30.

Then, the delivery center terminal 40 delivers the products of the specified transmission devices 60-1 to 60-n to a customer in which the transmission devices 60-1 to 60-n to which the line design change is required are installed based on the specified positional information on the transmission devices 60-1 to 60-n (Step A11).

In the sites where the transmission devices 60-1 to 60-n to which the line design change is required are installed, the products of the transmission devices 60-1 to 60-n delivered from the delivery center terminal 40 are accepted (Step A12), and the products are installed in the transmission devices 60-1 to 60-n (Step A13).

When the installation of the products is completed to the transmission devices 60-1 to 60-n, the transmission devices 60-1 to 60-n transmit product installation completion notifications to the delivery center terminal 40 (Step A14).

When the product installation completion notification is transmitted, the delivery center terminal 40 transmits the design change information received from the vendor sales server 30 to the network monitoring control device 50 (Step A15).

When receiving the design change information from the delivery center terminal 40, the network monitoring control device 50 performs the line design change to the transmission devices 60-1 to 60-n based on the received design change information (Step A16).

Examples of the line design change include the design changes (addition/deletion) of the transmission devices 60-1 to 60-n, the path design change (the design change of the start point and the end point of the path), and the design change of the monitoring control channel or the like.

When the line design changes of the transmission devices 60-1 to 60-n are completed, the network monitoring control device 50 transmits a notification that the line design change is completed to the delivery center terminal 40 (Step A17).

When receiving the line design change completion notification from the network monitoring control device 50, the delivery center terminal 40 transmits the line design change completion notification to the vendor sales server 30 (Step A18).

When receiving the line design change completion notification from the delivery center terminal 40, the vendor sales server 30 performs the billing processing generated by the line design change based on the line design change information (Step A19).

When the billing processing is completed, the vendor sales server 30 transmits the billing information generated by the line design change and the line design change completion notification to the line design server 20 (Step A20).

When receiving the billing information and the line design change completion notification from the vendor sales server 30, the line design server 20 transmits the billing information and the line design change completion notification to the user terminal 10 (Step A21).

When receiving the billing information and the line design change completion notification from the line design server 20, the user terminal 10 displays the billing information and the line design change completion notification on the display unit (Step A22).

Thus, in the line design system of the exemplary embodiment, the line design changes of the transmission devices 60-1 to 60-n can be automatically performed, so that the time necessary to the line design changes of the transmission devices 60-1 to 60-n can be shortened.

The design of the monitoring control channel can also automatically be changed. Therefore, the trouble of manually changing the design of the monitoring control channel according to the line design change can be saved in installing the products of the transmission devices 60-1 to 60-n to which the line design change is required.

The above-mentioned exemplary embodiment is a preferred exemplary embodiment of the present invention and the present invention is not limited to the above-mentioned exemplary embodiment, and it is possible for those skilled in the art that various changes and substitutions of the exemplary embodiment can be made without departing from the scope of the present invention.

For example, in the case where the request for line condition change is generated, the line design server 20 transmits the information on the transmission devices 60-1 to 60-n to which the change request is performed and the information on the monitoring control channels set to the transmission devices 60-1 to 60-n to the network monitoring control device 50, and the network monitoring control device 50 receives the information on the transmission devices 60-1 to 60-n and the information on the monitoring control channels, whereby any system mode can be constructed in the line design system of the exemplary embodiment when the monitoring control channels of the transmission devices 60-1 to 60-n can be set based on the received information on the transmission devices 60-1 to 60-n and the information on the monitoring control channels.

In the line design system of the exemplary embodiment, in the case where the request for line condition change is generated, the line design server 20 transmits the information on the transmission devices 60-1 to 60-n to which the change request is performed and the information on the monitoring control channels set to the transmission devices 60-1 to 60-n to the management device such as the vendor sales server 30 and the delivery center terminal 40, and when receiving the information on the transmission devices 60-1 to 60-n and the information on the monitoring control channels, the management devices 30 and 40 specify the transmission devices 60-1 to 60-n to which the change request is performed based on the information on the transmission devices 60-1 to 60-n, and manages the installation states of the specified transmission devices 60-1 to 60-n. When the installation of the transmission devices 60-1 to 60-n to be changed is completed, the management devices 30 and 40 transmit the information on the transmission devices 60-1 to 60-n and the information on the monitoring control channels to the network monitoring control device 50. When receiving the information on the transmission devices 60-1 to 60-n and the information on the monitoring control channels, the network monitoring control device 50 can construct any system mode when the monitoring control channels of the transmission devices 60-1 to 60-n can be set based on the received information on the transmission devices 60-1 to 60-n and the received information on the monitoring control channels.

The control operation of each communication device comprising the line design system of the above-mentioned exemplary embodiment can be performed by hardware, software, or a composite configuration of the hardware and software.

In the case where the processing is performed by the software, a program in which a processing sequence is recorded can be executed by installing the program in a memory of a computer incorporated in the dedicated hardware, or the program can be executed by installing the program in a general-purpose computer which can perform various kinds of processing.

For example, the program can previously be recorded in a hard disk or ROM (Read Only Memory) which is of a recording medium. Alternatively, the program can be stored (recorded) tentatively or eternally in a removable recording medium such as a floppy disk, a CD-ROM (Compact Disc-Read Only Memory), a MO (Magneto optical) disk, a DVD (Digital Versatile Disc), a magnetic disk, and a semiconductor memory or the like. Such a removable recording medium can be provided as so-called package software.

In addition to the installation of the program in the computer from the above-mentioned removable recording medium, the program can wirelessly be transferred to the computer from a download site, or the program can be transferred to the computer through the network such as LAN (Local Area Network) and the Internet. In the computer, the transferred program can be received and installed in the recording medium such as the built-in hard disk.

The line design system can be formed such that not only the control operation is performed in time series according to the processing operation of the above-mentioned exemplary embodiment but also the control operation is performed concurrently or separately according to processing capability of the device performing the processing or if needed. The line design system of the above-mentioned exemplary embodiment can be formed by a logical set of plural devices, or line design system of the embodiment can be formed such that the devices exist in the same chassis.

The present invention can be applied to service for being able to automatically perform the line design change.

What is claimed is:

1. A line design system comprising:
a transmission device which comprises a network;
a line design device which manages a line condition of said transmission device; and
a control device which controls a monitoring control channel of said transmission device,
wherein said line design device includes a transmission unit which transmits information on a transmission device to which a request for changing a line condition is made and information on a monitoring control channel set to the transmission device to said control device when the change request is made, and said control device includes a control unit which sets a monitoring control channel of the transmission device based on the information on said transmission device and the information on said monitoring control channel when receiving the information on said transmission device and the information on the monitoring control channel.

2. The line design system according to claim 1, further comprising a management device which manages an installation condition of said transmission device,
wherein said line design device transmits information on a transmission device to which a request for changing a line condition is made and information on a monitoring control channel set to the transmission device to said management device when the change request is made,
said management device includes:
a management unit which specifies a transmission device to which the change request is performed based on the information on said transmission device when receiving the information on said transmission device and the information on said monitoring control channel, and manages the installation state of the specified transmission device; and
a transmission unit which transmits the information on said transmission device and the information on said monitoring control channel to said control device, and
said control device sets the monitoring control channel of the transmission device based on the information on the transmission device and the information on said monitoring control channel when receiving the information on said transmission device and the information on said monitoring control channel.

3. The line design system according to claim 2, wherein said management device transmits the information on said transmission device and the information on said monitoring control channel to said control device when installation of the transmission device managed by said management unit is completed.

4. A line design method performed in a line design system including a transmission device which comprises a network; a line design device which manages a line condition of said transmission device; and a control device which controls a monitoring control channel of said transmission device,
said line design device performs:
a transmission step of transmitting information on a transmission device to which a request for changing a line condition is made and information on a monitoring control channel set to the transmission device to said control device when the change request is made; and
said control devices performs:
a control step of setting a monitoring control channel of the transmission device based on the information on the transmission device and the information on the monitoring control channel when the information on said transmission device and the information on said monitoring control channel are received.

5. The line design method according to claim 4, wherein said line design system comprises a management device which manages an installation condition of said transmission device,
said line design device transmits information on a transmission device to which a request for changing a line condition is made and information on a monitoring control channel set to the transmission device to said management device when the change request is made,
said management device performs:
a management step of specifying a transmission device to which the change request is made based on information on said transmission device when receiving the information on said transmission device and the information on said monitoring control channel, and of managing the installation condition of the specified transmission device; and
a transmission step of transmitting the information on said transmission device and the information on said monitoring control channel to said control device, and
said control device sets the monitoring control channel of the transmission device based on the information on the transmission device and the information on said monitoring control channel when receiving the information on said transmission device and the information on said monitoring control channel.

6. The line design method according to claim 5, wherein said management device transmits the information on said transmission device and the information on said monitoring control channel to said control device when installation of the transmission device managed in said management step is completed.
